(19) United States
(12) Patent Application Publication
(10) Pub. No.: US 2010/0028723 A1
(43) Pub. Date: Feb. 4, 2010

(54) POWER CELL APPARATUS WITH THREE DIMENSIONAL INTERCONNECT

(76) Inventor: Chaz Haba, Sherman Oaks, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/182,949

(22) Filed: Jul. 30, 2008

(51) Int. Cl. H01M 14/00; H01M 6/42

(52) U.S. Cl. 429/7; 429/159

(57) ABSTRACT

An integrated power cell having three dimensional interconnected component cells is provided. The integrated power cell includes a plurality of individual battery cells connected in serial and parallel form to create a battery pack. The battery back is coupled to control circuitry by low resistance lead connections. The cell includes a plurality of blocks of individual component batteries, each battery having a positive terminal and a negative terminal. A first compound connector couples all of the positive terminals of a first block of cells to each other and to all of the negative terminals of a second, adjacent block of cells. A second compound connector couples all of the negative terminals of the first block of cells to each other and to all of the positive terminals of a third, adjacent block of cells. A compound positive lead connector couples one set of terminals and a compound negative lead connector coupled another set of terminals to an input circuit and an output circuit.

### BACKGROUND

As the demand for energy grows, efficient power storage becomes critical to enabling alternative transportation and energy technologies.

One solution to large scale power storage is the use of a battery pack including a large number of component batteries. One such pack is disclosed in U.S. Pat. No. 6,465,986 which shows a series of individual component batteries configured to provide a two-dimensional battery network having X columns and Y rows. Each column in the network includes Y batteries electrically connected in series to form a string of batteries. Each of the X columns or strings 14 are then further electrically connected together in parallel, to produce a network of X columns of batteries connected together in parallel, each of the X columns having Y batteries 12 connected together in series. Finally, each of the individual component batteries is further configured with compound interconnections 16, such that each of the individual component batteries is connected in parallel with all adjacent individual component batteries in the same row.

The two dimensional array is coupled by a conductor of sufficient current carrying capacity.

### SUMMARY

An integrated power cell having three dimensional interconnected cells is provided. The integrated power cell includes a plurality of individual battery cells connected in serial and parallel form to create a battery pack. The battery back is coupled to control circuitry by low resistance lead connections. The structure of the battery interconnections and the leads in combination with the control circuitry allows simultaneous charging and discharging of the integrated power cell.

In one embodiment, the cell includes a plurality of blocks of individual component batteries, each battery having a positive terminal and a negative terminal. A first compound connector couples all of the positive terminals of a first block of cells to each other and to all of the negative terminals of a second, adjacent block of cells. A second compound connector couples all of the negative terminals of the first block of cells to each other and to all of the positive terminals of a third, adjacent block of cells. A compound positive lead connector couples one set of terminals and a compound negative lead connector coupled another set of terminals to an input circuit and an output circuit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a plan view of an integrated power cell in accordance with the present technology.

FIG. 2A is a top view and FIG. 2B is a bottom view of a plurality of individual battery cells utilized in the integrated power cell 100.

FIG. 3 is a view of the three-dimensional representation of the connections made in the battery pack in accordance with the present technology.

FIG. 4 is a schematic diagram of the input and output circuits utilized in the present technology.

FIGS. 5 and 6 are isometric views illustrating the connection of a plurality of individual batteries to a conductor connector in accordance with the present technology.

FIGS. 7 and 8 are isometric views illustrating the soldering method for a battery pack in accordance with the present technology.

FIG. 9 is an overview of an interconnection between two integrated power cells in accordance with the present technology.

FIG. 10 is a graph illustrating the relationship between the number of cells in a system versus the resistance/impedance in an integrated power cell.

FIG. 11 is a graph illustrating the relationship between the number of cells in a system versus the percentage of failed and surviving cells.

### DETAILED DESCRIPTION

An integrated power cell having three dimensional interconnected component battery cells is provided. The integrated power cell includes a plurality of individual battery cells connected in serial and parallel form to create a battery pack. The battery pack is coupled to control circuitry by low resistance lead connections. The structure of the battery interconnections and the leads in combination with the control circuitry allows simultaneous charging and discharging of the integrated power cell.

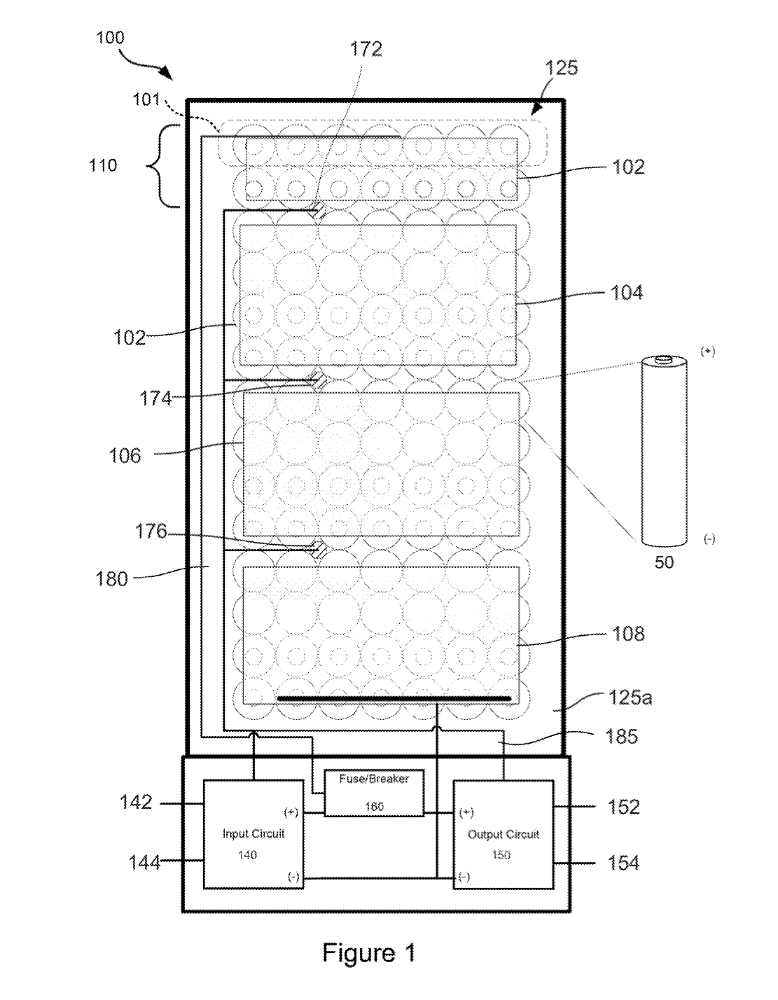

FIG. 1 is a plan view of an integrated power cell 100 created in accordance with the present technology. An integrated power cell 100 includes a plurality of individual battery cells 50 arranged in an interconnected structure as described herein. Each cell has a positive node and a negative node. A series of cells 50 may be arranged in a row 105, with each cell in the row having the same orientation. In one embodiment, two such rows 110, all cells having the same orientation, are arranged into a block 110. It will be recognized as a particular arrangement of the number of cells in a particular row, and rows in a particular block 110 may be varied in any number of different manners. As illustrated in FIG. 1, each block 110 is a 2×7 block of cells, the cells are arranged in alignment so that all the positive terminals of the cells are adjacent to one another, and all the negative terminals of the cells are adjacent to one another.

The integrated power cell 100 is housed in a housing comprised of a first region 125a housing the battery pack 125, and a second region 135a housing electronics and input/output leads.

Also shown in FIG. 1 is an input circuit 140, an output circuit 150, and a fuse or circuit breaker 160. The battery pack 125 includes a positive terminal coupling lead 180 and a negative coupling lead 185. The positive lead 180 is connected to connection plate 102 and the negative lead 185 to connection plate 109 (not shown in FIG. 1). The positive lead 180 is coupled to the fuse or circuit breaker 160 and the positive input terminals of the input circuit 140 and output circuit 150. The negative lead 185 is coupled to the negative terminal of the input circuit and negative terminal of the output circuit 150. Thermal fuses 172, 174, 176 are provided between adjacent blocks in the integrated cell and coupled to the input and output circuits. The terminal fuses 172, 174, and 176 protect against an overheating and cuts off power to the system in the event of an increase in the ambient temperature within which the battery pack is maintained. Each integrated power cell 100 has two input leads 142, 144 and two output leads 152, 154.

In accordance with the technology, a three dimensional interconnection is provided between respective blocks 110 by the conductive plate 102-109. This connection creates a massively parallel coupling where the conductive connections are created between all positive and all negative connections in respective adjacent blocks. This feature promotes balancing of individual cells to within one milli-volt. Each cell, is, for example, a 5 cM lithium ion cell which has an output voltage of approximately 3.78 volts. As will be readily understood, other types of cells may be utilized in accordance with the present technology.

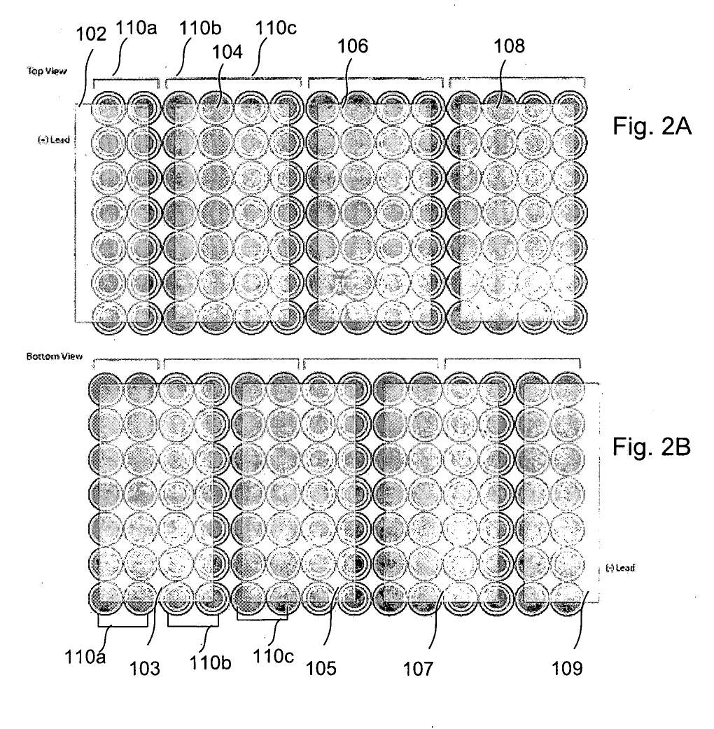

FIGS. 2A and 2B illustrate the serial coupling between adjacent blocks 110. Each alternating block is connected to an adjacent block in a serial fashion. That is, the negative terminals of all cells in a first given block are coupled to the positive terminals of an adjacent second block on a first side, while the positive terminals of the cells in the first block are coupled to the negative terminals of a third block. This is illustrated by blocks 110a-110c. Block 110b has negative terminals coupled to the positive terminals of block 110c by conductor 104, and positive terminals coupled to block 110a by conductor 103.

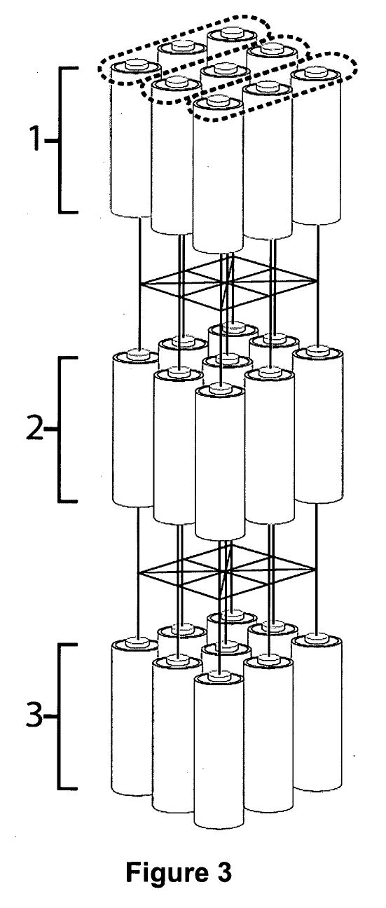

FIG. 3 illustrates the three dimensional nature of the coupling between adjacent packages of cells. Three cell packages 1, 2 and 3 are illustrated in FIG. 3. Using the plurality of conductor plates 102, 104, 106 and 108, on the top portion of the cells, as well as the second plurality of conductor plates 103, 105, 107 and 109 on the bottom of the cell pack, a three dimensional connection between the positive and negative terminals of each cell is made. As discussed below, each conductor plate 102-109 is comprised of a 0.005 inch thick, ⅛ hard nickel 201 metal plate. As illustrated in FIGS. 1-3, adjacent anodes and cathodes of each cell of adjacent cell blocks 110 are coupled three dimensionally. That is, because of the nickel plate, conductive paths exist between each anode and cathode in adjacent cell blocks. Likewise, all anodes are coupled together, and all cathodes are coupled together.

The use of a nickel anode plate or compound interconnection in combination with a welding lead on each of the cells and an increased connection area on each of the nickel connections provides a lower resistance and impedance for each integrated cellular block. By maximizing the area of the lead to be welded on the nickel plate, resistance is minimized which greatly avoids heat generation that can be caused from long charging and discharging of the battery, high current flow, or both. A detailed process of welding nickel plates and leads is discussed below.

This compound connection is distinguished from the connection provide in U.S. Pat. No. 6,465,986 where a two dimensional array of connections, provided by individual conductors, is provided. The compound connection improves the reliability and redundancy of the present technology, allowing the voltage balance of the individual cells to be more accurate (1 mv compared with 2.5 mv in U.S. Pat. No. 6,465,986)

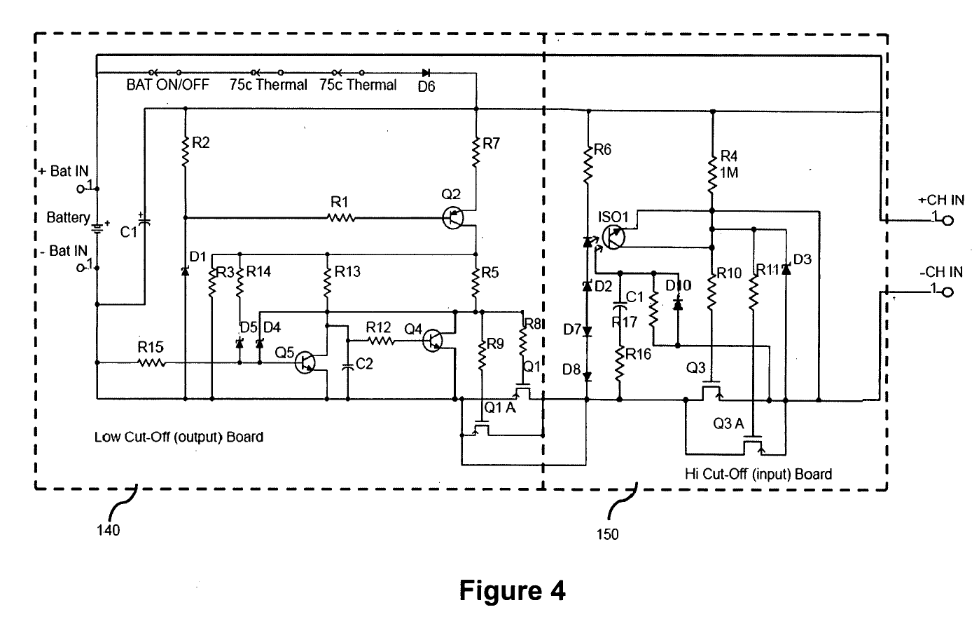

FIG. 4 is a schematic diagram of the input circuit 140 and the output circuit 150. The input board 140 and output board 150 may be implemented as a single integrated circuit board. In one embodiment, an input board or output board is implemented by not populating those elements on the board. Each circuit 140, 150 uses two field effect transistors (FETs). FETs Q1 and Q1A are provided on the low cut-off side and FETS Q3 and Q3A are provided on the high cut-off side. The number and/or power qualities of the FETS can be increased on either side to support large amounts of current and/or power qualities of the FETS can be flowing through each side of the system.

When the circuit operates as an input or output boards only two FETs operate at any one time. When all devices are populated, and the board is acting as in input or output, the other two FETs act as diodes preventing current flow from flowing in the portion of the board not being used. Although these FETs are not being used in the traditional sense, they are acting as diodes and thereby generating heat on the board. As the current increases in the board, then the two unused FETs generate proportionally more heat which could be detrimental to the system. Therefore, the devices may not be populated when dedicated input or output boards are used to avoid this issue.

The input board limits the voltage applied to the battery pack to prevent overcharging while the output board cuts off output to the voltage leads to prevent complete discharge of the battery pack.

The components on the output board include in a capacitor C1 which filters battery pack BT1 (125) signal and maintains a stable voltage. FETS Q1 and Q1A are power FETs for the output which turn on and off according to the signals from transistors Q2, Q4 and Q5. Q2 turns everything on this side of the board on and off when the voltage output from the battery is too low as determined by D1 and R2 for the low side. Resistor R1 supplies current to the transistor Q2. Diode D1 works in conjunction with R2, Q2 and D5 to set the voltage limits of the system. In one embodiment, the low voltage output is cut off at 24 Volts. Input is cut off at 29 Volts in. Resistor R2 works with D1 to set the voltage level of the output stage. FET Q5 turns on output FETs Q1 and Q1A and allows for a hard turn on.

Transistors Q4, Q5, resistor R12, and capacitor C2 function to protects the output FETs Q1 and Q1a and prevents hard cut-off of the voltage at low levels. Resistors R5, R9 and R8 filter low extraneous currents from entering into FETs Q1 and Q1A. This power is grounded by Q4, Q5, R12, and C2. Diode D6 provides power spike protection. Switches Bat On/Off, Battery thermal protection, and heat sink (board thermal protection) are all safeties on the negative line.

The components on the input board include opto-isolator ISO1 and related components R16, C3, D10, and R17. The opto-isolator and related components identifies a high voltage input and signal to the input board FETs Q3 and Q3A. Resistors R10 and R11 act as filters on the incoming voltage. Diode D3 allows for a hard start and works with resistor R4, diode D2, resistor R6. Diodes D7 and D8 are utilized to set the V high of the input board; more components can be added to exactly tune the high Voltage setting of the input board.

Note that a completely populated board provides a unique flexibility to the present technology. In the embodiment shown in FIGS. 1-2, two dedicated boards having two inputs or two outputs each are shown. However, any number of input or output leads may be utilized in the integrated power cell by providing one or more dedicated (unpopulated) input or output boards, or fully populated input/output boards. If a fully populated board is utilized such as that shown in FIG. 4, the additional leads can be used as either an input or an output segment. It will be recognized that any number of input output boards, and any number of lead pairs may be utilized with individual battery packs 125 to provide greater flexibility in power cell creation.

As noted above, coupling of the conductor plates to the individual cells to form interconnected blocks, and the connection of the leads to the block assembly, allows a number of unique advantages for the integrated power cell. Initially, battery pack 125 assembly begins with a matching of individual battery cells 50 according to voltage. This ensures maximum performance and a complete balancing due within one milli-volt for all cells within the battery back 125. The compound interconnection provided by places 102-109 ensures this balance is maintained between the cells when in operation.

In one embodiment, all battery packs 125 consist of cells 50 which have a voltage of 3.78 volts. In the embodiment disclosed herein, fourteen (14) rows, each row consisting of seven (7) cells, are utilized. Other combinations and numbers of rows and cells per row can be utilized. Each row of seven cells 50 is generally secured using a securing mechanism such as a filament tape 720. Other methods of securing the cells in blocks may be utilized. All cells have the same positive and negative orientation within each row 105 and block 110. Each row of seven cells which are secured to each other may then be secured to an adjacent row using the securing mechanism, and adjacent blocks may be secured to each other in a similar manner.

Construction of the battery pack 125 begins by forming voltage matched cell blocks 110. In the present embodiment, 7 such blocks are formed. The blocks are then coupled to each other in the alternating terminal arrangement illustrated in FIGS. 1-2. Thermal fuses 172, 174, 176 may be placed between individual blocks 110 or a combination of two blocks in the battery pack 125. In one embodiment, three thermal fuses are utilized, with the positions of the fuses illustrated in FIG. 1. Thermal fuses can be positioned between adjacent cell groups in a manner such that the fuses minimizes the amount of room required by the fuse in the crevices between adjacent rows to ensure a tight fit between the rows of cells.

Once all blocks 110 are arranged, interconnection of the blocks is performed using the conductive plates. Each conductive plate 102 through 109 is comprised of nickel 201 metal plate roll which is 0.005-inch thick and ⅛ hard. The plates are flattened to ensure the highest transfer of energy between the plate and the cells 50 to which it is coupled.

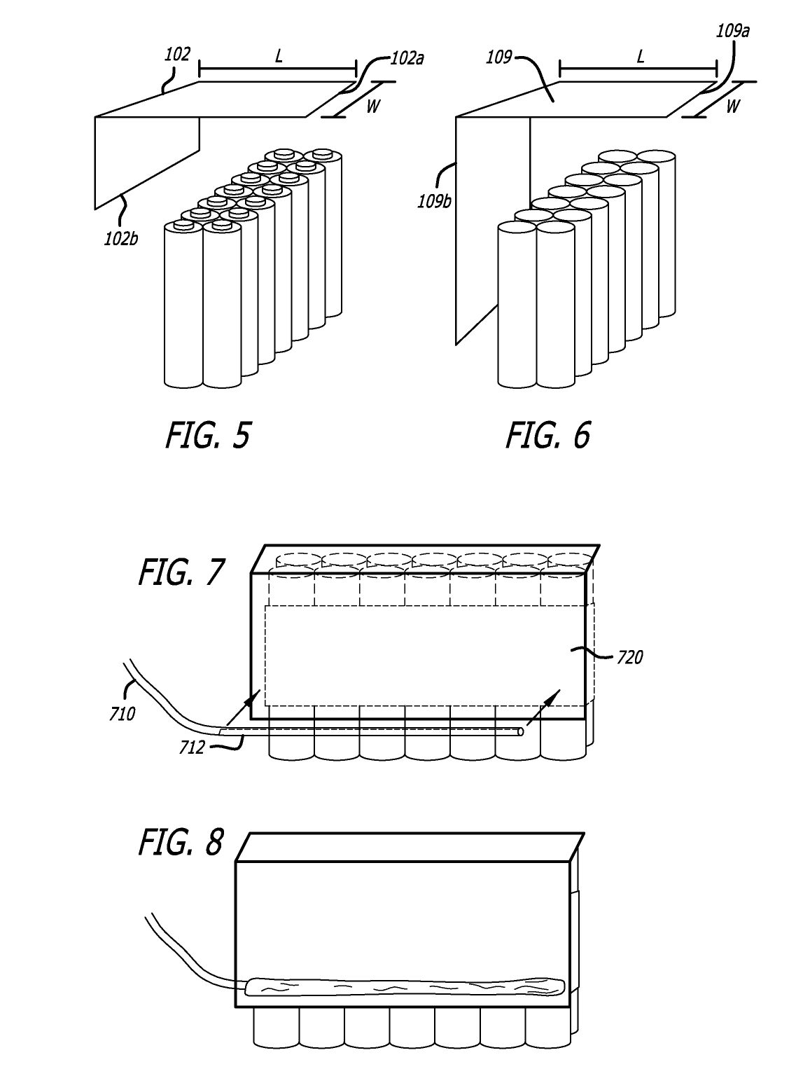

Two plates which will comprise lead connection plates are bent in a fashion illustrated in FIG. 5 and FIG. 6 to form a positive lead coupling and a negative lead coupling, respectively, for the battery pack 125. Each coupling plate 102, 109 has a coupling area 102A, 109A which has a width W. The main difference between the two coupling planes is the length of the attachment portions 102B and 109B, respectively. The attachment portion 102B and 109B allow the connection leads to be placed in different physical locations within the battery pack storage container 125a.

FIGS. 7 and 8 illustrate connecting one of the coupling leads 185 which is to be welded to a coupling plate 102. Each lead is comprised of eight 12 gauge AWG wires of varying lengths covered in insulation 710. Insulation from the wire is stripped to reveal the bare wire 712. In one embodiment, the coupling areas 102A and 109A has a width of 1¼ inches and a length of 4 1/16 inches. In such an example, four inches of bare lead wire 712 is utilized to connect the electrical leads 185 to the coupling plate 102 or 109. It will be recognized that the bare wire portion is approximately equal to the length of the coupling plate 102. It will be noted that the bare portion may be increased where the wire is laid diagonally across the coupling area 102a.

Optionally, each strand of bare wire 710 is twisted to increase the rigidity and conductivity of the bare portion of the wire. Connection is performed by soldering the bare portion of the wire 712 to the connection region. Prior to soldering, flux is applied to the stripped end of the conductive wire 712. A soldering bar comprising 50% tin and 50% lead is then melted and the bare portion 712 of the wire is dipped into the melted solder. The conductive lead wire is then pressed against the nickel plate, and a small amount of flux is applied to the top edge of the connection portion 102B or 109B of the conductive plate 102 or 109, respectively. The bare wire 712 is placed adjacent to the connection portion 102B or 109B, and using a small amount of solder, laid across the length of the connection portion using the solder in the dipped portion of the bare wire 712 to solder the bare wire including solder to the connector 102 or 109. In one embodiment, soldering begins near the insulation end of the wire and proceeds to the fully exposed end of the bare wire 712. Solder is then reapplied over the initially soldered portion to ensure rigidity in the connection. The soldered connection, illustrated in FIG. 8, provides reduced resistance to the voltage running through the battery pack.

Once the electrical leads are connected to the connection plates 102 and 109, each connection plate 102 through 109 is then electrically spot welded to each contact of the cells in the battery pack 125. Once all the connectors are welded to each of the cells, the battery pack leads 180, 185 are provided the input and output circuits, and the other components of the integrated power cell are mounted the components into a case. One example, a metal case which defines regions 135A and 125A can be utilized.

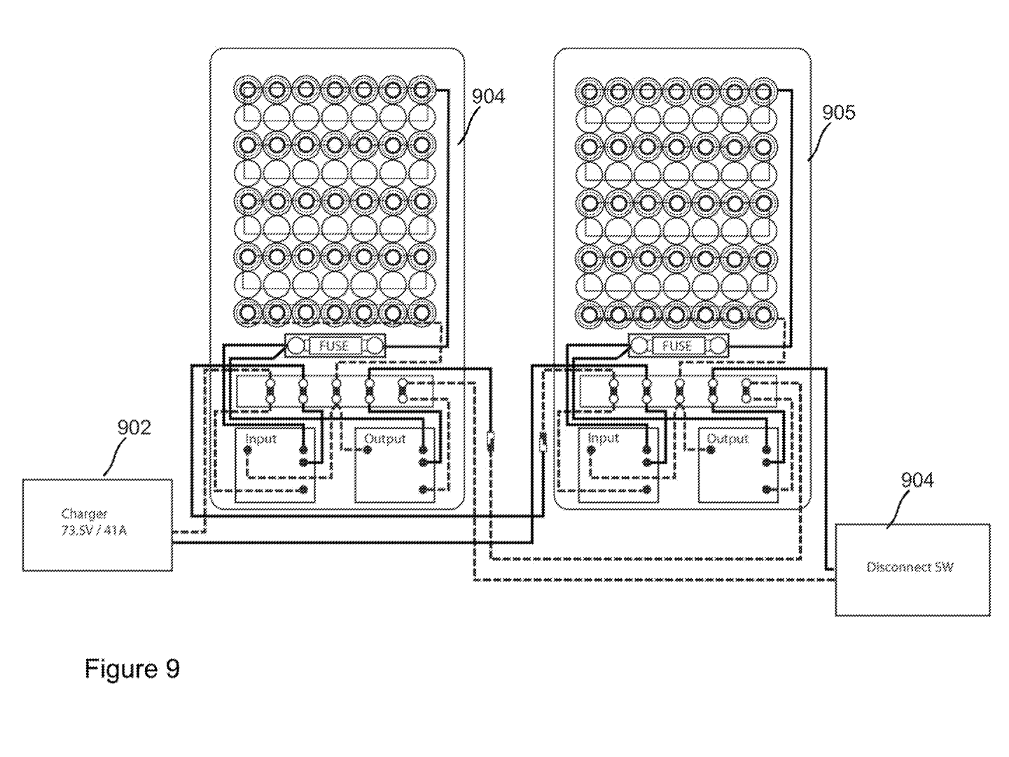

FIG. 9 illustrates the interconnection between a first integrated power cell 101a and a second integrated power cell 101b. As illustrated therein, Input and output leads of two different cells 100 can be cross coupled in series. The input leads of call 100a are coupled to a charger 902, while the output leads are coupled to a switch 904. Given that constant charging and discharging can occur at the same time, a unique aspect of the present technology allows cells to be coupled in various fashions to provide a number of integrated power solutions. A number of different configuration options are available. Different combinations of integrated cells enable one to avoid the use of DC to DC converters. For example, a 28 volt DC PV system can charge four integrated power cell systems and feed energy to an inverter system at 56 volts DC. This is done by configuring four integrated power cells all on parallel for the input side and two N series parallel for the output side. A table illustrating the various combinations of input and output combinations for a number of different integrated power cells is listed below:

| | # iCeLs | | | | | | | | |
|---|---|---|---|---|---|---|---|---|---|
| | 1 | 2 | 3 | 4 | 5 | 6 | 7 | 8 | 9 |
| #input | 1 | 2 | 2 | 3 | 2 | 4 | 2 | 5 | 3 |
| combination | | | | | | | | | |
| # output | 1 | 2 | 2 | 3 | 2 | 4 | 2 | 5 | 3 |
| combination | | | | | | | | | |
| # system | 1 | 4 | 4 | 9 | 4 | 16 | 4 | 25 | 9 |
| combination | | | | | | | | | |

The number of combinations in configuring X number of integrated power cells can be expressed as: ((X/2)+1)² (for an even number of integrated power cells). Alternatively for a “square” number of integrated power cells (formed into a series of rows and columns of an even number of cells 100) it can be expressed as: n² (where n=number of factor, square number of cells, i.e., 2, 4, 9, 16, 25.)

As a result of the interconnection system utilized in the present technology, the integrated energy system's resistance and impedance decreases with an increasing number of energy cells or equivalent collections of cells and series that are configured and parallel. The results of the multi-cellular integrated energy system with a resistance and impedance lower than that an equivalent energy capacity system with only a single cell.

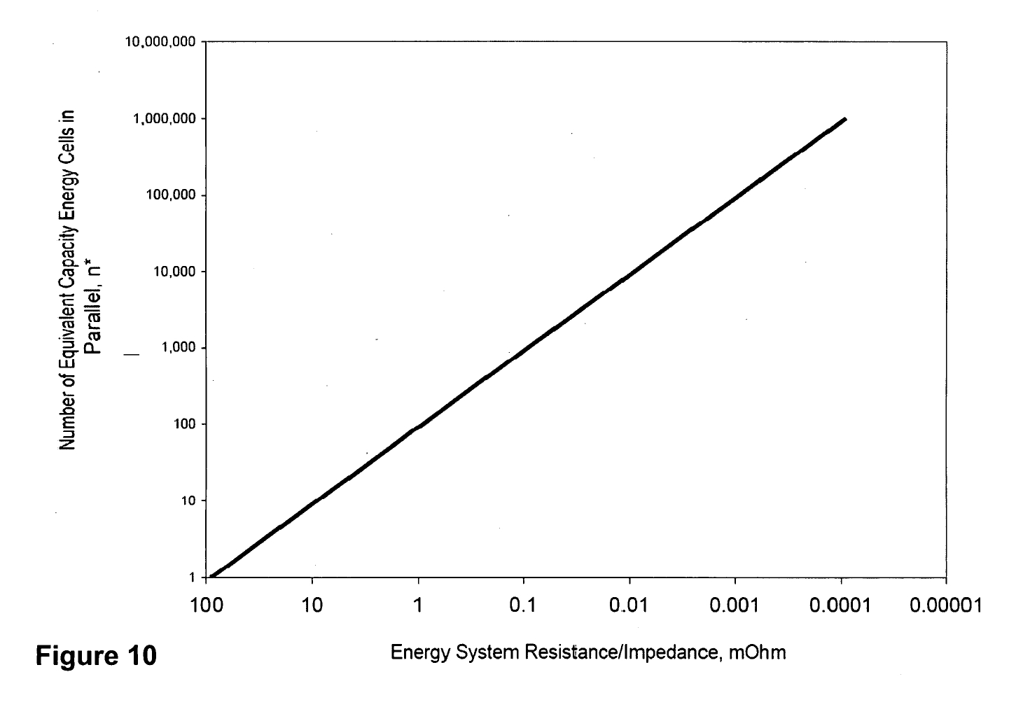

FIG. 10 illustrates a log plot of the integrated cell 100 resistance relative to the number of cells in parallel. The technology leads to less loss due to resistive heating, longer cell life due to minimized heating losses and more reliability and longer mean time between failures due to a longer cell life. In addition, failures between adjacent cells are accommodated for by other cells in the system.

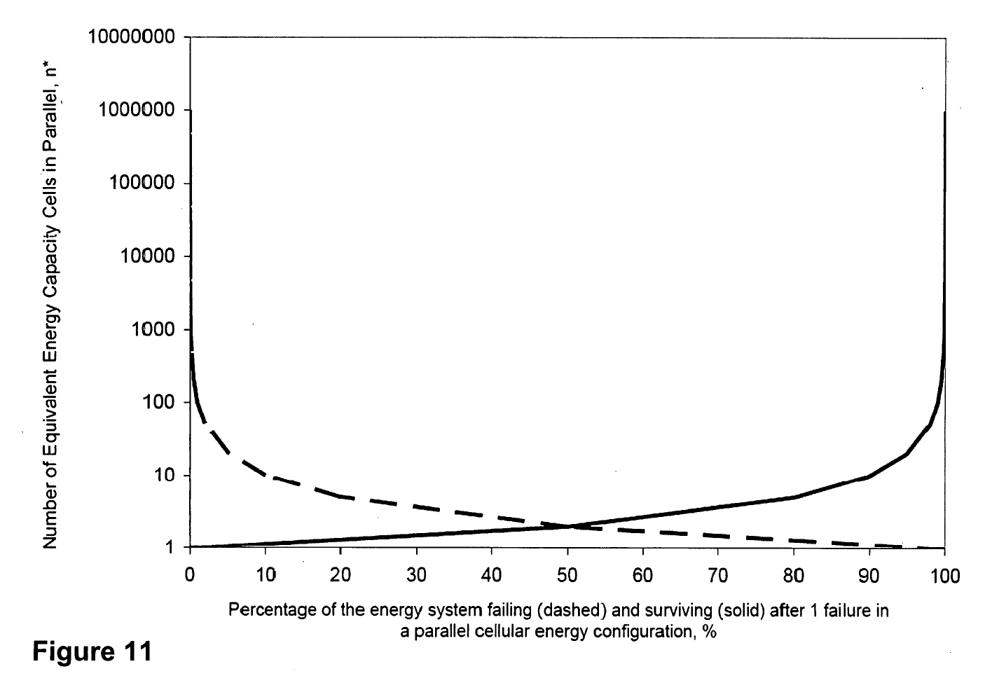

FIG. 11 demonstrates the survival percentage of the integrated energy system and how this percentage increases with the increasing number of cells which are configured in parallel. For any number of cells configured in parallel, the percentage of individual cells 50 in the integrated power cell 100 after a single failure event improves as the number of cells increases. For any number of cells configured in parallel, the percentage of failure of the integrated energy system on a whole decreases. When a cell 50 in the system fails, the integrated call 100 system will continue to operate at lower current and at the same potential minus the savings attributed to the parallel configuration of the resistance/impedance from the larger number of cells.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An integrated power cell, comprising:
a plurality of blocks of individual component batteries, each block comprising at least two rows of batteries, each battery having a positive terminal and a negative terminal, each having the same orientation of such that in a given row, all positive terminals of each cell are positioned adjacent to each other and those in one adjacent row, and all negative terminals of each cell are positioned adjacent to each other and those in at least one adjacent row; and
a planar compound connector in contact with and coupling all of the positive terminals of at least one block of cells to each other, and in contact with and coupling of the negative terminals of an adjacent block of cells.

2. The integrated power cell of claim 1, wherein the compound connector includes at least a first lead connector portion and a terminal connector portion, the terminal connector portion coupled to all the negative terminals of said at least one block of cells, the lead connection portion having a length and having a lead interconnection coupled thereto.

3. The integrated power cell of claim 2 wherein the lead interconnection comprises a length of conductive wire having a length substantially matching the length of the lead connection portion and being soldered to the lead connection portion.

4. The integrated power cell of claim 3, further including at least a second lead connector coupled to said at least adjacent block of cells, the second lead connector coupled to at least all the positive terminals of said at least one block of cells.

5. The integrated power cell of claim 1 wherein the compound connection is a nickel plate engaging each of said positive or negative terminals.

6. The integrated power cell of claim 1 wherein each individual component battery comprises a lithium-ion power cell having a tested voltage matched to within 1 milli-volt:

7. An integrated power cell, comprising:
a plurality of blocks of individual component batteries, each battery having a positive terminal and a negative terminal, each having the same orientation of such that, in a given block, all positive terminals of each cell are positioned adjacent to each other and all negative terminals of each cell are positioned adjacent to each other;
a first compound connector comprising a first conductive plate in contact with each of the positive terminals of a first block of cells thereby coupling the positive terminals to each other and in contact with all of the negative terminals of a second, adjacent block of cells;
a second compound connector comprising a second conductive plate in contact with each of the negative terminals of the first block of cells thereby coupling the negative terminals to each other and in contact with all of the positive terminals of a third, adjacent block of cells;
a compound positive lead connector coupled to all of the positive terminals of the second block of cells to each other and to a positive electrical lead;
a compound negative lead connector coupled to all of the positive terminals of the third block of cells to each other and to a negative electrical lead.

8. The integrated power cell of claim 7 further including an input circuit and an output circuit, the input circuit being coupled to the positive electrical lead and the negative electrical lead, and the output circuit being coupled to the negative electrical lead and the positive electrical lead.

9. The integrated power cell of claim 8 wherein said input circuit includes two electrical input leads, and the output circuit includes two electrical output leads.

10. The integrated power cell of claim 8 further including at least one combined input/output circuit having two electrical input/output leads.

11. The integrated power cell of claim 10 wherein each compound connector is a nickel plate.

12. The integrated power cell of claim 11 further including a lead interconnection between the positive lead and a compound positive lead connector which comprises a length of conductive wire having a length substantially matching a length of the compound positive lead connector and being soldered to the compound positive lead connector.

13. The integrated power cell of claim 11 further including a lead interconnection between the negative lead and a compound negative lead connector which comprises a length of conductive wire having a length substantially matching a length of the compound negative lead connector and being soldered to the compound negative lead connector

14. The integrated power cell of claim 7 wherein each individual component battery comprises a lithium-ion power cell having a tested voltage matched to within 1 milli-volt.

15. An integrated power cell system, comprising:
a first integrated power cell comprising:
a first plurality of blocks of individual component batteries, each battery having a positive terminal and a negative terminal, each having the same orientation of such that, in a given block, all positive terminals of each cell are positioned adjacent to each other and all negative terminals of each cell are positioned adjacent to each other, each block comprising one or more rows of cells;
a first compound connector plate connected to and coupling all of the positive terminals of a first block of cells to each other and to all of the negative terminals of a second, adjacent block of cells;
a second compound connector plate connected to and coupling all of the negative terminals of the first block of cells to each other and to all of the positive terminals of a third, adjacent block of cells;
a first compound positive lead connector coupled to the first compound connector and to a positive electrical lead;
a first compound negative lead connector coupled to the second compound connector and to a negative electrical lead;
an first input circuit coupled to the positive and negative electrical lead and having a first positive input lead and a second positive input lead;
a first output circuit coupled to the positive and negative electrical leads and having a first positive output leads and a second positive output;
a second integrated power cell comprising:
a second plurality of blocks of individual component batteries;
a third compound connector plate connected to and coupling all of the positive terminals of a fourth block of cells to each other and to all of the negative terminals of a fifth, adjacent block of cells;
a fourth compound connector plate connected to and coupling all of the negative terminals of the third block of cells to each other and to all of the positive terminals of a sixth, adjacent block of cells;
a second compound positive lead connector coupled to the third compound connector and to a positive electrical lead;
a second compound negative lead connector coupled to the fourth compound connector and to a negative electrical lead;
an second input circuit coupled to the positive and negative electrical lead and having a third positive input lead and a fourth positive input lead;
a second output circuit coupled to the positive and negative electrical leads and having a third positive output lead and a fourth positive output lead.

16. The system of claim 15 wherein ones of said first, second, third and fourth positive input lead are interconnected to ones of said ones of said first, second, third and fourth positive output leads to interconnect the first and second integrated power cells.

17. The system of claim 15 further including a plurality of integrated power cells, each of the plurality having an identical configuration and at least a first and second input lead and a first and second output lead, the plurality being interconnected to form a power storage system having a capacity equal to a storage capacity of each cell multiplied by the number of cells in the plurality.
